(19) United States
(12) Patent Application Publication
(10) Pub. No.: US 2009/0147385 A1
(43) Pub. Date: Jun. 11, 2009

(54) PRISM SHEET AND METHOD FOR MAKING THE SAME

(75) Inventors: TUNG-MING HSU, Tu-Cheng (TW); SHAO-HAN CHANG, Tu-Cheng (TW)

Correspondence Address: PCE INDUSTRY, INC.;ATT. Steven Reiss, 458 E. LAMBERT ROAD, FULLERTON, CA, 92835, US

(73) Assignee: HON HAI PRECISION INDUSTRY CO., LTD., Tu-Cheng (TW)

(21) Appl. No.: 12/052,745

(22) Filed: Mar. 21, 2008

(30) Foreign Application Priority Data
Dec. 10, 2007 (CN) 200710202961.0

(51) Int. Cl. F21V 5/02; F21V 7/04; B29D 11/00

(52) U.S. Cl. 359/831; 264/2.7; 359/599

(57) ABSTRACT

An exemplary prism sheet includes a transparent main body. The transparent main body has a surface. A plurality of elongated protrusions protrude from the surface of the main body. Each of the elongated protrusions extends along a first direction. A width and a height of one or more elongated protrusions vary along the first direction. Methods for making the prism sheet are also provided.

### BACKGROUND OF THE INVENTION

1. Field of the Invention

The present invention relates to prisms, and particularly, to a prism sheet used in a liquid crystal display device, and methods for making the prism sheet.

2. Discussion of the Related Art

FIG. 9 is an exploded, side cross-sectional view of a typical liquid crystal display device 100 employing a typical prism sheet 10. The liquid crystal display device 100 includes a housing 11 and a plurality of lamps 12 positioned in the housing 11. The liquid crystal display device 100 further includes a light diffusion plate 13, a prism sheet 10, and a liquid crystal display (LCD) panel 15 stacked on the housing 11 in that order. The prism sheet 10 includes a base layer 101 and a prism layer 103 formed on the base layer 101. The prism layer 103 has a plurality of prism lenses 105 having a triangular cross section.

Light from the lamps 12 enters the diffusion plate 13 and becomes scattered. Thus, scattered light leaves the light diffusion plate 13 and enters the prism sheet 10. The scattered light travels through the prism sheet 10 and is refracted out at the prism layer 103 of the prism lenses 105. Thus, the refracted light leaving the prism sheet 10 is concentrated by the prism layer 103 and brightness (illumination) of the prism sheet 10 is increased. The refracted light then propagates into the LCD panel 15.

Generally, a method of manufacturing the prism sheet 10 includes the following steps: first, a melted ultraviolet(UV)-cured transparent resin is coated on the base layer 101 to form V-shaped lenses, then the melted ultraviolet-cured transparent resin is solidified to form the prism lenses 105. The prism lenses 105 can be easily damaged or scratched due to their poor rigidity and mechanical strength of the prism layer 103.

In addition, the prism lenses 105 are generally regularly arranged and extend along a direction parallel to one edge of the prism sheet 10. The prism lenses 105 are prone to be aligned similarly to pixels of the liquid crystal display panel 15, consequently, moiré patterns may occur between the prism sheet 10 and the pixel pitch of the liquid crystal display panel 15. In order to reduce or eliminate the moiré patterns and protect the prism lenses 105 of the prism sheet 10, the liquid crystal display device 100 should further include an upper light diffusion film 14 on the prism sheet 10. However, although the upper light diffusion film 14 and the prism sheet 10 are in contact with each other, a plurality of air pockets still exist at the boundary between the light diffusion film 14 and the prism sheet 10. When the liquid crystal display device 100 is in use, light passes through the air pockets, and some of the light undergoes total reflection at one or another of the corresponding boundaries. In addition, the upper light diffusion film 14 may absorb an amount of the light from the prism sheet 10. As a result, a brightness of light illumination of the liquid crystal display device 100 is reduced.

Therefore, a new prism sheet and a method for making the prism sheet are desired in order to overcome the above-described shortcomings.

### SUMMARY

In one aspect, a prism sheet according to a preferred embodiment includes a transparent main body. The transparent main body has a surface. A plurality of elongated protrusions protrude from the surface of the main body. Each of the elongated protrusions extends along a first direction. A width and a height of at least one of the elongated protrusions vary along the first direction.

In another aspect, a method for making a prism sheet according to a preferred embodiment includes: providing a cutting device, the cutting device comprising a cutter, a table, and a control unit, the table being controlled to move up and down by the control unit, the cutter having a blade that is rotatable along its center axis; providing a mold insert preform on the table, the mold insert preform having a flat surface; the blade rotating and being moved to etch the flat surface of the mold insert preform along a first direction, simultaneously, the table being driven to move up and down by the control unit according to a predetermined manner, thereby a first elongated depression being formed in the flat surface, wherein a width and a depth of the first elongated depression vary according to the predetermined manner; repeating the step of forming the first elongated depression to form a plurality of first elongated depressions in the flat surface, thereby a mold insert is achieved; using the mold insert to form the prism sheet.

Other advantages and novel features will become more apparent from the following detailed description of various embodiments, when taken in conjunction with the accompanying drawings.

### BRIEF DESCRIPTION OF THE DRAWINGS

The components in the drawings are not necessarily drawn to scale, the emphasis instead being placed upon clearly illustrating the principles of the present prism sheet and method for making the same. Moreover, in the drawings, like reference numerals designate corresponding parts throughout several views, and all the views are schematic.

FIG. 1 is a side, cross-sectional view of a liquid crystal display device using a prism sheet according to a first preferred embodiment of the present invention.

FIG. 2 is an isometric view of the prism sheet of FIG. 1.

FIG. 3 is a side, cross-sectional view of the prism sheet of FIG. 2, taken along line III-III.

FIG. 4 is an isometric view of a prism sheet according to a second preferred embodiment of the present invention.

FIG. 5 is a side, cross-sectional view of a cutting device for making a mold insert, the mold insert is used to making a prism sheet of the present invention.

FIG. 6 is an isometric view of the mold insert made by the cutting device shown in FIG. 5.

FIG. 7 is a side, cross-sectional view of the mold insert of FIG. 6, taken along line VII-VII.

FIG. 8 is a side, cross-sectional view of another cutting device for making a mold insert, the mold insert is used to making a prism sheet of the present invention.

FIG. 9 is a side cross-sectional view of a conventional liquid crystal display device employing a typical prism sheet.

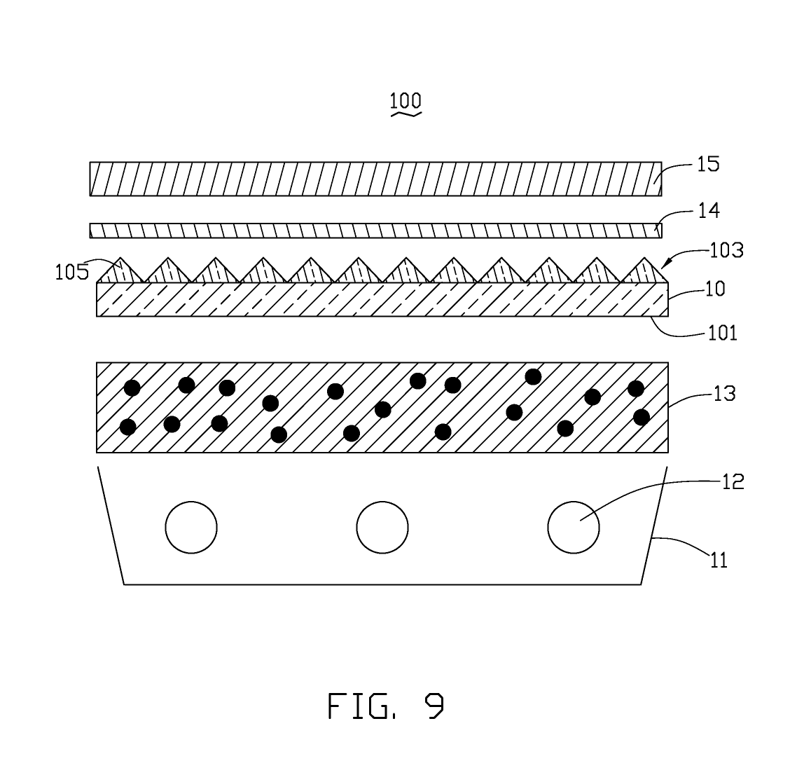

### DETAILED DESCRIPTION OF THE PREFERRED EMBODIMENTS

Reference will now be made to the drawings to describe preferred embodiments of the present prism sheet in detail.

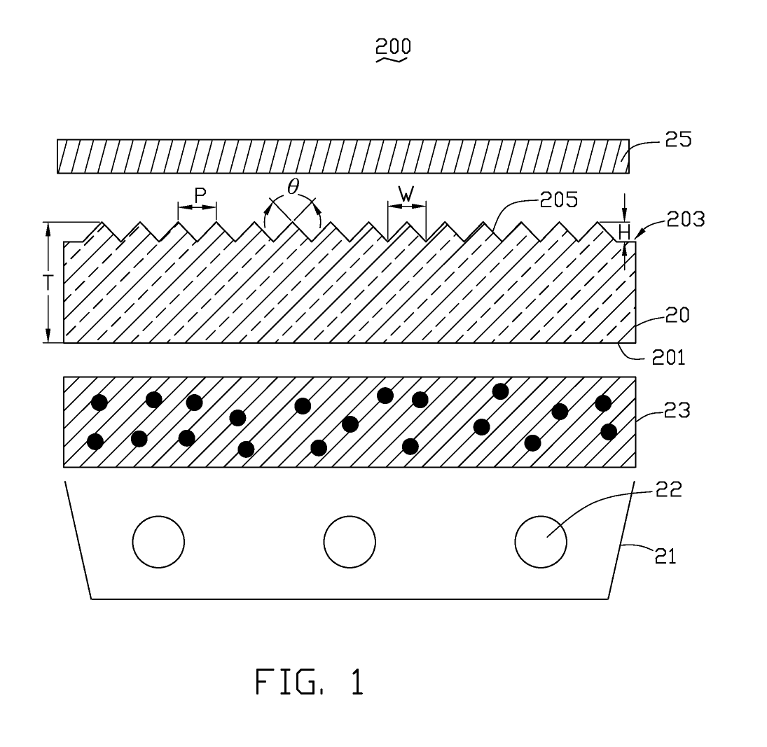

Referring to FIG. 1, a liquid crystal display device 200 in accordance with a first preferred embodiment of the present invention is shown. The liquid crystal display device 200 includes a prism sheet 20, a housing 21, a plurality of lamps 22, a light diffusion plate 23, and a liquid crystal display panel 25. The lamps 22 are regularly aligned above a base of the housing 21. The light diffusion plate 23, the prism sheet 20, and the liquid crystal display panel 25 are stacked on the top of the housing 21 in that order.

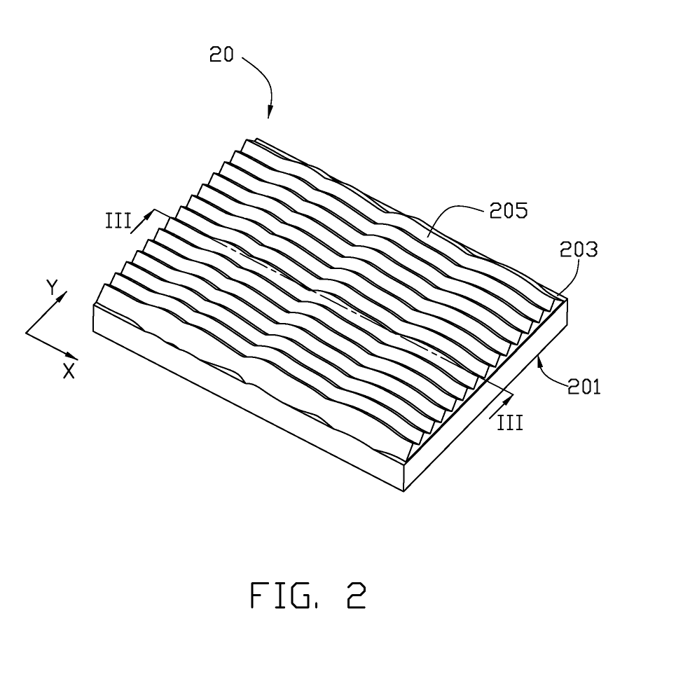

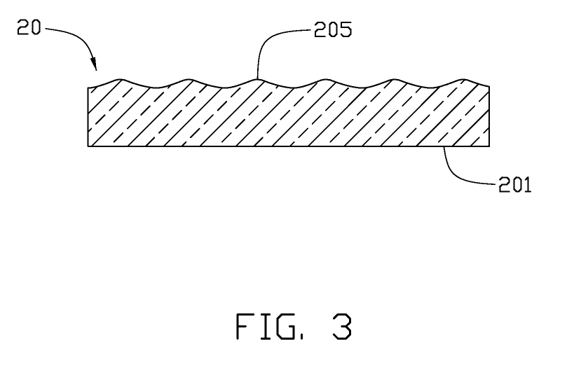

Referring to FIGS. 2 and 3, the prism sheet 20 includes a transparent main body. The transparent main body includes a first surface 201 and a second surface 203. The first surface 201 and the second surface 203 are on opposite sides of the main body. Furthermore, the second surface 203 forms a plurality of elongated protrusions 205. The prism sheet 20 is positioned on the light diffusion plate 23 such that the first surface 201 is adjacent to the light diffusion plate 23 and the second surface 203 faces away from the light diffusion plate 23.

Each of elongated protrusions 205 extends along an X-direction (a longitudinal direction of the elongated protrusion 205) parallel to an edge of the prism sheet 20. A width W and a height H of each of the elongated protrusions 205 vary along the X-direction in a predetermined pattern.

The elongated protrusions 205 have V-shaped cross-sections when the cross section is taken along a Y-direction (see FIG. 2 for X and Y-directions ). A vertex angle θ defined by the V-shaped cross-sections of the X-direction is preferably in a range from about 85 degrees to about 95 degrees. A pitch P between adjacent elongated protrusions 205 along the Y-direction is configured to be in the range from about 0.025 millimeters to about 1 millimeter. Shapes and sizes of the elongated protrusions 205 are substantially the same.

The first surface 201 is a planar surface. The elongated protrusions 205 of the light output surface 203 are configured for converging light emitted from the second surface 203. A thickness T of the prism sheet 20 is greater than that of a conventional prism sheet. The thickness T of the prism sheet 20 is preferably in a range from about 0.4 millimeters to about 4 millimeters. The prism sheet 20 can be made of transparent material selected from the group consisting of polycarbonate (PC), polymethyl methacrylate (PMMA), polystyrene (PS), copolymer of methylmethacrylate and styrene (MS), and any suitable combination thereof.

Referring to FIG. 1 again, the lamps 22 can be point light sources such as light emitting diodes or linear light sources such as cold cathode fluorescent lamps. The housing 21 is configured to have a high reflectivity, however, an extra coating can be further applied on the interior. In the illustrated embodiment, the lamps 22 are cold cathode fluorescent lamps. The housing 21 is made of a highly reflective metal.

Moreover, in contrast to the conventional prism sheet, the prism sheet 20 of the present invention is integrally formed by injection molding technology. Injection molding technology allows the prism sheet 20 to be easier to mass-produce than that of the conventional prism. Conventional prism sheet are formed by solidifying melted ultraviolet-cured transparent resin and as such the prism lenses are easily damaged and/or scratched due to poor rigidity and mechanical strength. The present prism sheet, when compared to the conventional prism sheet, has better rigidity and mechanical strength. Therefore, the present prism sheet 20 has a relative high reliability.

In addition, orientations of the inclined surfaces of the elongated protrusions 205 could vary in accordance with the various requirements of different viewing angles. In other words, the prism sheet 20 could be orientated according to the different viewing angle requirements. Furthermore, because the arrangement of the elongated protrusions 205 are not aligned with the LCD pixels of the liquid crystal display panel 25, moiré patterns between the prism sheet 20 and the pixel pitch of liquid crystal display panel 25 is minimized or even eliminated.

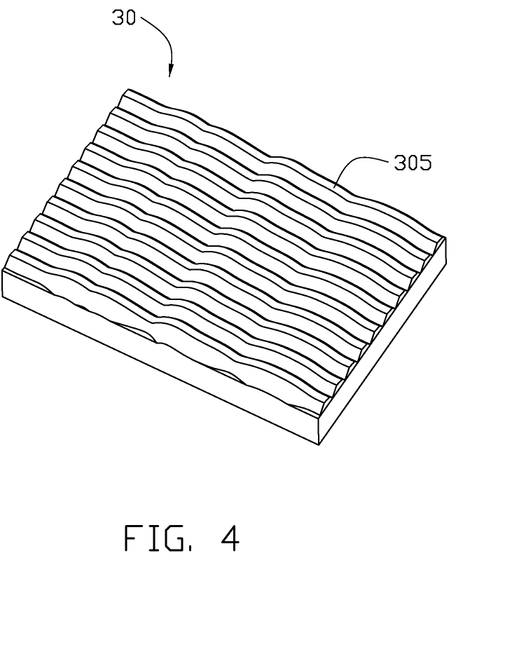

Referring to FIG. 4, a prism sheet 30 in accordance with a second preferred embodiment of the present invention is shown. The prism sheet 30 is similar in principle to the prism sheet 20. A plurality of elongated protrusions 305 protrude on a second surface of the prism sheet 30. A width and a height of each of the elongated protrusions 305 vary along a longitudinal direction of the elongated protrusions 305 in a predetermined pattern. However, each of elongated protrusions 305 has a trapezoidal cross section taken along a direction perpendicular to the longitudinal direction. An angle formed by side surfaces of each of the elongated protrusion 305 is preferably in a range from 85 degrees to 95 degrees.

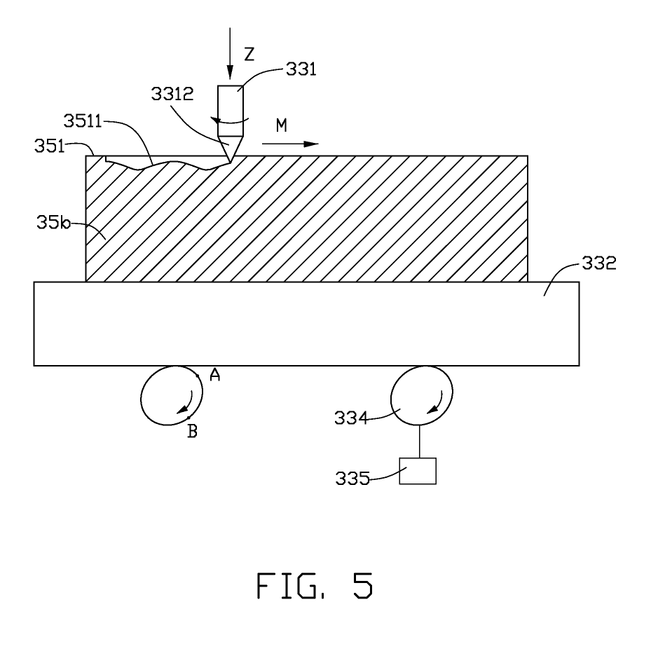

Referring to FIG. 5, a cutting device 33 for making a mold insert is depicted. The prism sheet 20 can be made by an injection molding method with the mold insert. The cutting device 33 includes a cutter 331, a table 332, a plurality of cams 334, and a control unit 335. The table 332 is positioned on the cams 334. The cams 334 are driven to rotate by the control unit 335, thus the table 332 moves up and down in a first predetermined manner according to the cams 334. The cutter 331 has a conical blade 3312. A vertex angle defined by a cross-section of the conical blade 3312 is configured to be in a range from about 85 degrees to about 95 degrees. The conical blade 3312 of the cutter 331 can be driven to rotate along a Z-axis by the control unit 335. The Z-axis is a center axis of the conical blade 3312 of the cutter 331.

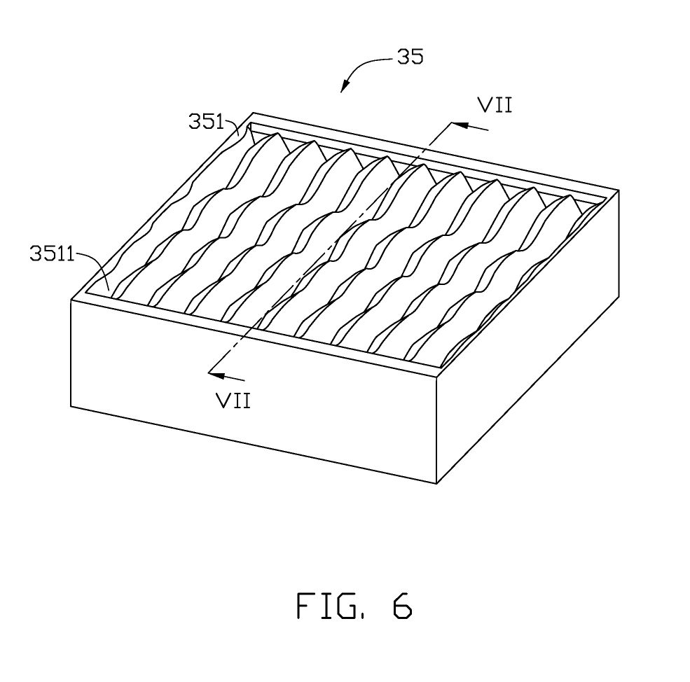

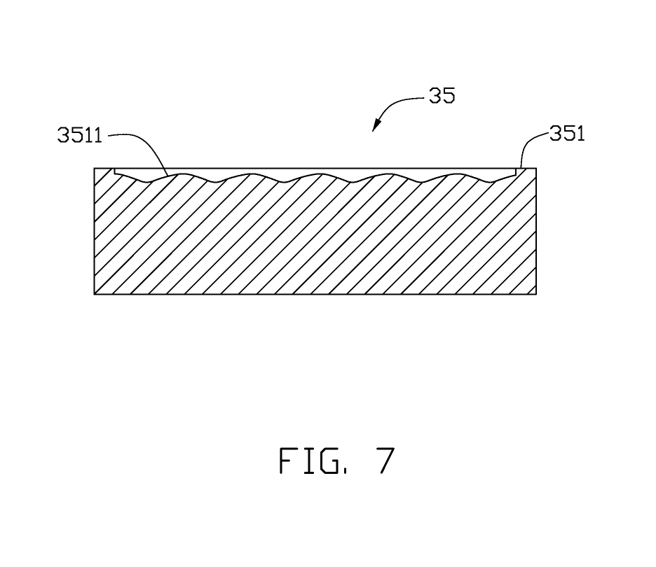

In processing, a mold insert preform 35b is provided on the table 332 of the cutting device 33. The blade 3312 is rotating and driven to etch a flat surface 351 of the mold insert preform 35b along a first direction M. Simultaneously, the table 332 of the cutting device 33 is driven to move up and down periodically by the cams 334 according to a first predetermined manner. Therefore, the flat surface 351 of the mold insert preform 35b defines a first elongated depression 3511 that extends along the first direction M. A width and a depth of the elongated depressions 3511 vary according to the first predetermined manner. The step of forming the first elongated depression 3511 is re-performed/re-applied to form a plurality of first elongated depressions 3511 in the flat surface 351. Thus, a mold insert 35, as shown in FIGS. 6, 7, using for making the prism sheet 20 is achieved. The prism sheet 20 is manufactured by injection molding method with the mold insert 35.

Furthermore, the blade 3312 can also be moved to etch the flat surface 351 of the mold insert preform 35b along a second direction (not shown). At the same time, the table 332 of the cutting device 33 can be driven to move up and down by the cams 334 according to a second predetermined manner. Therefore, the flat surface 351 of the mold insert preform 35b defines a second elongated depression (not shown) that extends along the second direction. A width and a depth of the second elongated depression vary according to the second predetermined manner. The step of forming the second elongated depression is reused/re-applied to define a plurality of second elongated depressions in the flat surface 351 that intersect with the first elongated depressions 3511.

It can be understood, in the above mentioned process, when forming some elongated depressions, the control unit 335 stops, thus elongated depressions with uniform depths and widths can be achieved. The blade 3312 can be other shape such as conical frustum, sphere, and so on.

In above mentioned process, the first direction and the second direction are linear. In alternative embodiment, the first direction and the second direction can be curved.

It can be understood that the prism sheet 20 also can be formed by hot pressing method. The process of the hot pressing method includes the following steps: providing a transparent substrate, heating the mold insert 35, after that the molding surface 351 of the mold insert 35 is pressed on the transparent substrate to form the prism sheet 20.

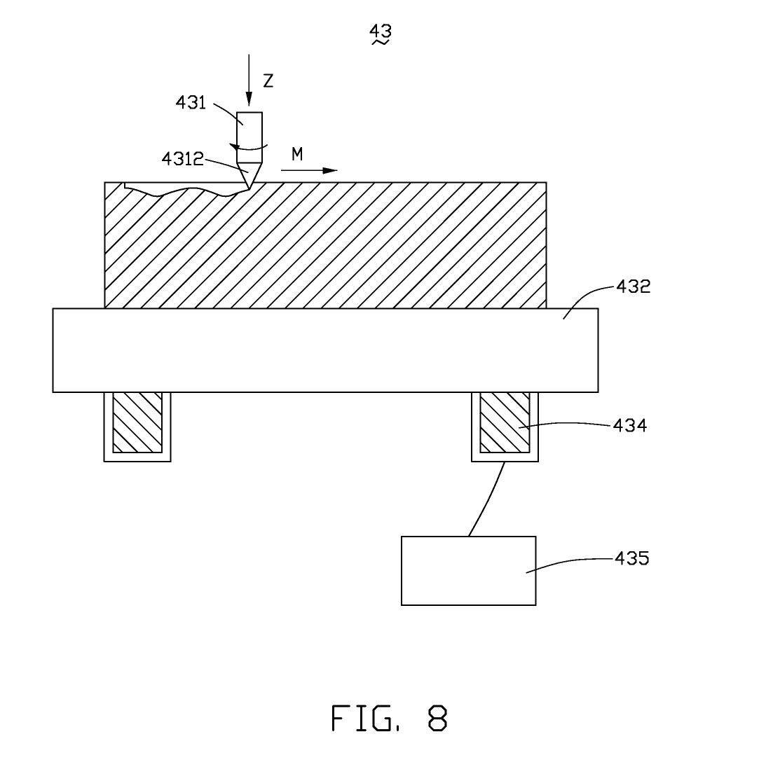

Referring to FIG. 8, another cutting device 43 for making a mold insert is provided. The cutting device 43 includes a cutter 431, a table 432, a plurality of piezoelectric members 434, and a control unit 435. The table 432 is positioned on the piezoelectric members 434. The piezoelectric members 434 are controlled to expand or shrink by the control unit 435, thus the table 432 moves up and down periodically during working. The cutter 431 has a conical blade 4312. A vertex angle of a cross-section of the conical blade 4312 is configured to be in a range from about 85 degrees to about 95 degrees. The cutting device 43 is similar in principle to the cutting device 33, except that, the cams 334 of the cutting device 33 are replaced by the piezoelectric members 434.

Finally, while various embodiments have been described and illustrated, the invention is not to be construed as being limited thereto. Various modifications can be made to the embodiments by those skilled in the art without departing from the true spirit and scope of the invention as defined by the appended claims.

What is claimed is:

1. A prism sheet comprising:
a transparent main body having a surface,
a plurality of elongated protrusions protruding from the surface of the main body, wherein each of the elongated protrusions extends along a first direction; a width and a height of at least one of the elongated protrusion vary along the first direction.

2. The prism sheet according to claim 1, wherein a pitch between adjacent the elongated protrusions along a second direction perpendicular to the first direction is in the range from about 0.025 millimeters to about 1 millimeter.

3. The prism sheet according to claim 1, wherein the elongated protrusions have V-shaped cross-sections taken along a second direction perpendicular to the first direction.

4. The prism sheet according to claim 3, wherein a vertex angle defined by the V-shaped cross-sections of the elongated protrusions is in a range from about 85 degrees to about 95 degrees.

5. The prism sheet according to claim 1, wherein the elongated protrusions have trapezoidal cross-sections taken along a second direction perpendicular to the first direction.

6. The prism sheet according to claim 5, wherein an angle formed by side surfaces of each of the elongated protrusion is in a range from about 85 degrees to about 95 degrees.

7. The prism sheet according to claim 1, wherein the thickness of the prism sheet is in the range from about 0.4 millimeters to about 4 millimeters.

8. The prism sheet according to claim 1, wherein the prism sheet can be made of transparent material selected from the group consisting of polycarbonate, polymethyl methacrylate, polystyrene, copolymer of methylmethacrylate and styrene, and any suitable combination thereof.

9. A method for making a prism sheet, comprising:
providing a cutting device, the cutting device comprising a cutter, a table, and a control unit, the table is controlled to move up and down by the control unit, the cutter having a blade that is rotatable along its center axis;
providing a mold insert preform on the table, the mold insert preform having a flat surface;
the cutter blade rotating and being moved to etch the flat surface of the mold insert preform along a first direction, simultaneously, the table being driven to move up and down by the control unit in a predetermined manner, thereby a first elongated depression being formed in the flat surface, wherein a width and a depth of the first elongated depression vary according to the predetermined manner;
repeating the step of forming the first elongated depression to form a plurality of first elongated depressions in the flat surface; and
using the mold insert to form the prism sheet.

10. The method for making a prism sheet according to claim 9, wherein the cutting device further comprises a plurality of cams controlled by the control unit, and the table is positioned on the cams.

11. The method for making a prism sheet according to claim 9, wherein the cutting device further comprises a plurality of piezoelectric members controlled by the control unit, and the table is positioned on the piezoelectric members.

12. The method for making a prism sheet according to claim 9, further comprising the following steps:
the cutter blade rotating and being moved to etch the flat surface of the mold insert preform along a second direction and simultaneously the table being driven to move up and down by the control unit according to a second predetermined manner, thereby a second elongated depression being formed in the flat surface, wherein a width and a depth of the second elongated depression vary according to the second predetermined manner, the second elongated depression intersecting with the first elongated depressions; and
repeating the step of forming the second elongated depression to form a plurality of second elongated depressions in the flat surface.

13. The method for making a prism sheet according to claim 9, wherein a shape of the blade is selected from a group consisting of conical frustum, sphere.

14. The method for making a prism sheet according to claim 13, wherein a shape of the blade is a cone, a vertex angle defined by a cross-section of the conical blade is configured to be in a range from about 85 degrees to about 95 degrees.

15. The method for making a prism sheet according to claim 9, wherein at least one of the first direction and the second direction is linear or non-linear.
